(19) United States
(12) Patent Application Publication
(10) Pub. No.: US 2018/0356757 A1
(43) Pub. Date: Dec. 13, 2018

(54) FIXING DEVICE AND IMAGE FORMING APPARATUS

(71) Applicant: FUJI XEROX CO., LTD., Tokyo (JP)

(72) Inventors: Jouta KOBAYASHI, Kanagawa (JP); Yasutaka GOTOH, Kanagawa (JP); Sou MORIZAKI, Kanagawa (JP); Masakazu TAKAHASHI, Kanagawa (JP); Yasushi NAGATA, Kanagawa (JP); Motoharu NAKAO, Kanagawa (JP)

(73) Assignee: FUJI XEROX CO., LTD., TOKYO (JP)

(21) Appl. No.: 15/808,844

(22) Filed: Nov. 9, 2017

(30) Foreign Application Priority Data
Jun. 9, 2017 (JP) 2017-114408

(51) Int. Cl. G03G 15/20

(52) U.S. Cl. CPC G03G 15/2089; G03G 15/2085

(57) ABSTRACT

A fixing device includes a pressing member that is rotatably held and performs pressing in one direction, a contact member that is rotatably held facing the pressing member, the contact member forming a nip portion through which a recording medium passes between the contact member and the pressing member, the contact member coming into contact with the recording medium, first regulating portions that protrude from portions adjacent to the contact member toward the pressing member at positions upstream and downstream of the nip portion in a rotation direction of the contact member to regulate a shape of the contact member, and a second regulating portion that is located in the nip portion and protrudes from a portion adjacent to the contact member toward the pressing member to regulate the shape of the contact member.

### CROSS-REFERENCE TO RELATED APPLICATIONS

This application is based on and claims priority under 35 USC 119 from Japanese Patent Application No. 2017-114408 filed Jun. 9, 2017.

### BACKGROUND

### Technical Field

The present invention relates to a fixing device and an image forming apparatus.

### SUMMARY

According to an aspect of the invention, a fixing device includes a pressing member that is rotatably held and performs pressing in one direction, a contact member that is rotatably held facing the pressing member, the contact member forming a nip portion through which a recording medium passes between the contact member and the pressing member, the contact member coming into contact with the recording medium, first regulating portions that protrude from portions adjacent to the contact member toward the pressing member at positions upstream and downstream of the nip portion in a rotation direction of the contact member to regulate a shape of the contact member, and a second regulating portion that is located in the nip portion and protrudes from a portion adjacent to the contact member toward the pressing member to regulate the shape of the contact member.

### BRIEF DESCRIPTION OF THE DRAWINGS

Exemplary embodiments of the present invention will be described in detail based on the following figures, wherein:

FIG. 1 illustrates the entire structure of an image forming apparatus;

FIGS. 2A and 2B illustrate a structure of a fixing device, where FIG. 2A is a schematic diagram of the fixing device and FIG. 2B is a partially enlarged view of a rectangular region indicated by a broken line in FIG. 2A;

FIGS. 3A to 3C illustrate a fixing device according to a first exemplary embodiment, where FIG. 3A is a schematic diagram of the fixing device, FIG. 3B is a sectional view of a heater with a projection shape, and FIG. 3C is a graph showing the curvature of a sheet;

FIGS. 4A to 4C illustrate a fixing device according to a second exemplary embodiment, where FIG. 4A is a schematic diagram of the fixing device, FIG. 4B is a sectional view of a heater with a projection shape, and FIG. 4C is a graph showing the curvature of a sheet;

FIGS. 5A to 5C illustrate a fixing device according to a third exemplary embodiment, where FIG. 5A is a schematic diagram of the fixing device, FIG. 5B is a sectional view of a support member with a projection shape, and FIG. 5C is a graph showing the curvature of a sheet; and

FIG. 6 illustrates a related portion of a fixing device according to a fourth exemplary embodiment.

### DETAILED DESCRIPTION

Exemplary embodiments of the present invention are described below in detail with reference to the appended drawings.

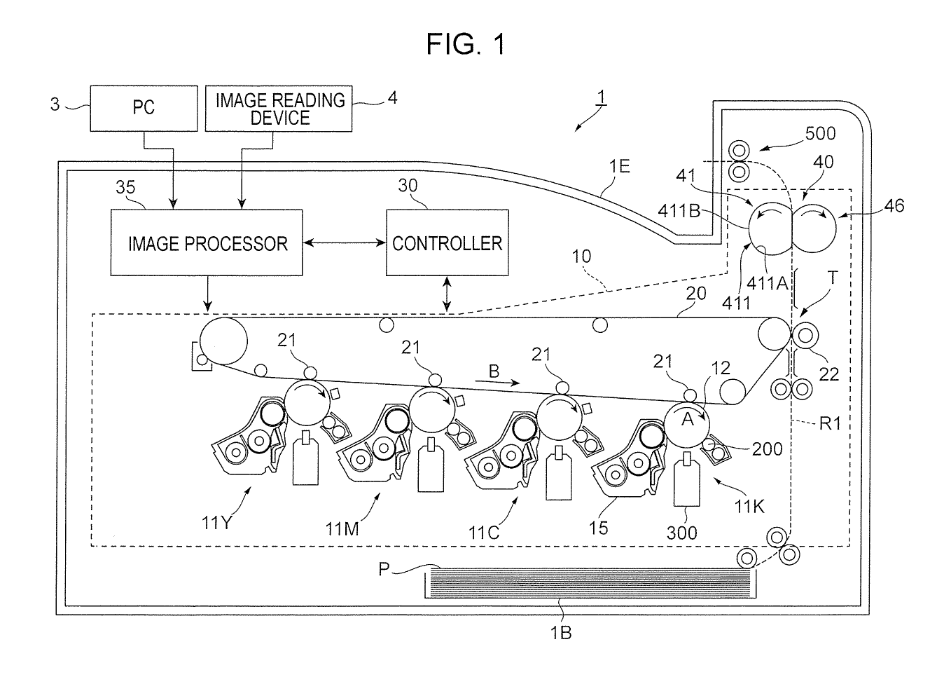

FIG. 1 illustrates an entire structure of an image forming apparatus 1.

The image forming apparatus 1 is a so-called tandem color printer. The image forming apparatus 1 includes an image forming portion 10 as an example of an image forming device. The image forming portion 10 forms images on a sheet P, which is an example of a recording medium, on the basis of image data of various colors.

The image forming apparatus 1 also includes a controller 30 and an image processor 35. The controller 30 controls the functional portions in the image forming apparatus 1. The image processor 35 performs image processing on image data from devices such as a personal computer (PC) 3 or an image reading device 4.

The image forming portion 10 includes four image forming units 11Y, 11M, 11C, and 11K (hereinafter also collectively and simply referred to as “image forming units 11”) arranged side by side at constant intervals.

The image forming units 11 have the same structure except for toner that they hold in respective developing devices 15 (described below). Each image forming unit 11 forms toner images (images) of yellow (Y), magenta (M), cyan (C), or black (K).

Each image forming unit 11 includes a photoconductor drum 12, a charging device 200, which charges the photoconductor drum 12, and an LED print head (LPH) 300, which exposes the photoconductor drum 12 to light.

The photoconductor drum 12 is charged by the charging device 200. The photoconductor drum 12 is also exposed to light by the LPH 300 to have an electrostatic latent image formed thereon.

Each image forming unit 11 also includes a developing device 15, which develops an electrostatic latent image formed on the photoconductor drum 12, and a cleaner (not illustrated) that cleans the surface of the photoconductor drum 12.

The image forming portion 10 also includes an intermediate transfer belt 20, to which different color toner images formed by the respective photoconductor drums 12 are transferred, and first transfer rollers 21, which sequentially transfer (first-transfer) the respective color toner images formed by the respective photoconductor drums 12 to the intermediate transfer belt 20.

The image forming portion 10 also includes a second transfer roller 22, which collectively transfers (second-transfers) the toner images transferred to the intermediate transfer belt 20 to a sheet P, and a fixing device 40, which fixes the toner images transferred to the sheet P onto the sheet P.

The fixing device 40 includes a fixing belt module 41, including a heater, and a pressing roller 46.

The fixing belt module 41 is disposed to the left of a sheet transport path R1 in the drawing. The pressing roller 46 is disposed to the right of the sheet transport path R1 in the drawing. The pressing roller 46 is pressed against the fixing belt module 41.

The fixing belt module 41 includes a film-like fixing belt 411, which comes into contact with a sheet P.

The fixing belt 411, which is an example of a contact member, includes, for example, a releasing layer located the outermost to touch the sheet P, an elastic layer located adjacent to and on the inner side of the releasing layer, and a base layer that supports the elastic layer.

The fixing belt 411 is endless and rotates in a counterclockwise direction in the drawing. The fixing belt 411 has an inner circumferential surface 411A to which a lubricating oil is applied to reduce sliding resistance between the fixing belt 411 and a component such as a heater, described below.

The fixing belt 411 comes into contact with a sheet P transported from the lower side in the drawing. A portion of the fixing belt 411 that comes into contact with the sheet P moves together with the sheet P. The fixing belt 411 then holds the sheet P together with the pressing roller 46 between the fixing belt 411 and the pressing roller 46 and presses and heats the sheet P.

The fixing belt module 41 includes a heater (described below) that heats the fixing belt 411 on the inner side of the fixing belt 411.

The pressing roller 46, which is an example of a pressing member, is disposed to the right side of the sheet transport path R1 in the drawing. The pressing roller 46 is pressed against an outer peripheral surface 411B of the fixing belt 411 and presses the sheet P (sheet P that passes along the sheet transport path R1) that passes between the fixing belt 411 and the pressing roller 46.

The pressing roller 46 is rotated by a motor (not illustrated) in the clockwise direction in the drawing. When the pressing roller 46 rotates in the clockwise direction, the fixing belt 411 receives a driving force from the pressing roller 46 and rotates in the counterclockwise direction.

The image processor 35 of the image forming apparatus 1 performs image processing on image data from the PC 3 or the image reading device 4, and transmits image data subjected to image processing to each image forming unit 11.

For example, in the image forming unit 11K for black (K), the photoconductor drum 12 is charged by the charging device 200 while rotating in the direction of arrow A, and exposed by the LPH 300 to light based on the image data transmitted from the image processor 35.

Thus, an electrostatic latent image corresponding to an image for black (K) is formed on the photoconductor drum 12. The electrostatic latent image formed on the photoconductor drum 12 is developed by the developing device 15, so that a toner image for black (K) is formed on the photoconductor drum 12.

Similarly, toner images for the colors of yellow (Y), magenta (M), and cyan (C) are respectively formed on the image forming units 11Y, 11M, and 11C.

The first transfer rollers 21 sequentially cause toner images for respective colors formed by the image forming units 11 to electrostatically adhere to the intermediate transfer belt 20 that moves in the direction of arrow B. Thus, toner images having different color toners superposed one on another are formed on the intermediate transfer belt 20.

The toner images formed on the intermediate transfer belt 20 are transported with the movement of the intermediate transfer belt 20 to a portion at which the second transfer roller 22 is located (second transfer portion T). At the timing when the toner images arrive at the second transfer portion T, a sheet P is fed from a sheet storage 1B to the second transfer portion T.

At the second transfer portion T, the transfer electric field formed by the second transfer roller 22 collectively and electrostatically transfers the toner images on the intermediate transfer belt 20 to the sheet P transported thereto.

Thereafter, the sheet P to which the toner images have been electrostatically transferred is released from the intermediate transfer belt 20 and transported to the fixing device 40.

In the fixing device 40, the fixing belt module 41 and the pressing roller 46 hold the sheet P therebetween. Specifically, the fixing belt 411 that rotates in the counterclockwise direction and the pressing roller 46 that rotates in the clockwise direction hold the sheet P therebetween.

Thus, the sheet P is pressed and heated to fix the toner images on the sheet P to the sheet P. The sheet P subjected to the fixing is transported to a sheet receiving portion 1E by discharging rollers 500.

The fixing device 40 is described now.

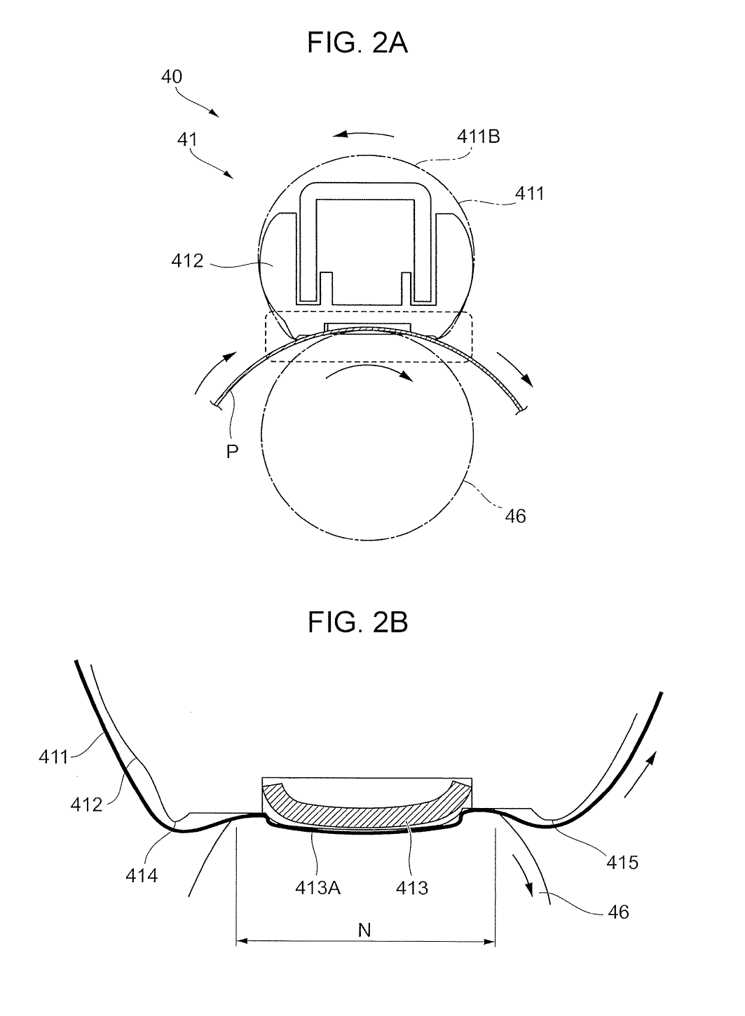

FIGS. 2A and 2B illustrate the structure of the fixing device 40, where FIG. 2A is a schematic diagram of the fixing device 40 and FIG. 2B is a partially enlarged view of a rectangular region indicated by a broken line in FIG. 2A.

As described above, the fixing device 40 illustrated in FIG. 2A includes the fixing belt module 41 and the pressing roller 46. The fixing belt module 41 includes a fixing belt 411 used to fix the toner image to the sheet P. The fixing belt 411 is pressed against the surface of the sheet P on which the toner images are formed.

The pressing roller 46, which is an example of a pressing member, is pressed against the outer peripheral surface 411B of the fixing belt 411 to press the sheet P that passes between the fixing belt 411 and the pressing roller 46.

Specifically, the pressing roller 46 is disposed in contact with the outer peripheral surface 411B of the fixing belt 411 and forms, between itself and the fixing belt 411, a nip portion or a pressing area N (hereinafter referred to as a nip portion N), through which the sheet P passes while being pressed.

In the exemplary embodiment, the sheet P is pressed by a heating source (described below) and the pressing roller 46 and heated by the heating source (described below) while passing through the nip portion N to fix the toner image to the sheet P.

As illustrated in FIG. 2A, the fixing belt module 41 includes a support member 412, which is located on the inner circumferential surface 411A of the fixing belt 411 to support the fixing belt 411.

The support member 412 has, at a portion facing the pressing roller 46, a recess that supports a heater 413, which heats the fixing belt 411. The heater 413, which is an example of a heat supply portion, includes a plate-shaped flat heater, and extends in the direction in which the fixing belt 411 moves and in the width direction of the fixing belt 411.

The heater 413 faces the pressing roller 46 to press the sheet P and has a structure that also has a heating effect. The flat heater of the heater 413 has a flat heating area, which ensures the nip portion N to reliably heat the sheet P. The structure including a heater having a flat heating area of a specific width is more easily bent in the axial direction (direction perpendicular to the plane of FIGS. 2A and 2B) than the structure in which the flat heating area has a width smaller than the specific width. The structure is more easily manufactured and reduces the manufacturing costs.

The heater 413 may be of a type that includes multiple components (separate type), that is, a heater lamp having a heating area and a fixing pad that fixes the heater lamp thereto. In this type of the heater 413, the pressing roller 46 is pressed against the heater fixing pad of the heater 413. In the present exemplary embodiment, however, the heater 413 is of a type that includes a single component having these functions (integrate type).

In the present exemplary embodiment, the heater 413 is a component separate from the support member 412. However, the heater 413 and the support member 412 may be integrated together.

As illustrated in FIG. 2B, in the present exemplary embodiment, the heater 413 feeds heat to the fixing belt 411 to heat the fixing belt 411. In the present exemplary embodiment, the pressing roller 46 is pressed against a contact-member facing surface 413A of the heater 413 with the fixing belt 411 interposed therebetween.

More specifically, as illustrated in FIG. 2B, the support member 412 includes an upstream protrusion 414, disposed upstream of the nip portion N, and a downstream protrusion 415, disposed downstream of the nip portion N.

More specifically, the upstream protrusion 414 and the downstream protrusion 415 of the support member 412 are disposed on the outer sides of the nip portion N, off the nip portion N. In other words, the upstream protrusion 414 is disposed upstream of the nip portion N in the sheet transport direction. The downstream protrusion 415 is disposed downstream of the nip portion N in the sheet transport direction. The upstream protrusion 414 and the downstream protrusion 415 according to the present exemplary embodiment have different shapes, but may have the same shape.

The above-described upstream protrusion 414 and the downstream protrusion 415 protrude toward the pressing roller 46. The upstream protrusion 414 and the downstream protrusion 415 are disposed to prevent a sheet from creasing in the axial direction, and to enhance fixing of an image to a sheet or releasability of a sheet.

Specifically, the upstream protrusion 414 allows the sheet P to lie along the heater 413 longer, to start being heated earlier, and to be heated longer (enhances fixing of an image to a sheet). The downstream protrusion 415 allows the sheet P to be reliably released from the fixing belt 411 (enhances releasability of a sheet).

The upstream protrusion 414 and the downstream protrusion 415 may exert a force of bending a sheet P at the entrance and the exit of the nip portion N to curl the fixed sheet P. Particularly, the sheet P that is being heated by the heater 413 receives a bending force, so that the sheet P is more likely to be curled.

The image forming apparatus 1 or the fixing device 40 according to the present exemplary embodiment has a structure that prevents deformation of the fixed sheet P.

The upstream protrusion 414 and the downstream protrusion 415 cause a transport path difference between the top and back surfaces of the sheet P and are more likely to cause so-called envelope creases. The structure that prevents deformation of the sheet P is capable of reducing envelope creases.

The present exemplary embodiment includes the upstream protrusion 414 and the downstream protrusion 415.

Alternatively, a structure that includes either one of the protrusions is conceivable. Specifically, examples of possible structures include a structure that includes the upstream protrusion 414 and the downstream protrusion 415, a structure that includes the upstream protrusion 414 without the downstream protrusion 415, and a structure that includes the downstream protrusion 415 without the upstream protrusion 414.

Now, a structure that prevents deformation of the fixed sheet P is specifically described.

The structure that prevents deformation of the fixed sheet P is described.

As illustrated in FIG. 2B, the heater 413 protrudes from a portion adjacent to the fixing belt 411 of the fixing belt module 41 toward the pressing roller 46 at the nip portion N. Specifically, the heater 413 has a projection shape curving out toward the pressing roller 46. This projection shape corrects the sheet P bent by the upstream protrusion 414 by bending the sheet P in the reverse (opposite) direction at the nip portion N, and then corrects the sheet P that is to be bent by the downstream protrusion 415 by bending the sheet P in advance in the reverse direction at the nip portion N.

To be more specific, the amount of protrusion of the heater 413 is determined to reduce the total curvature of the sheet P passing through the nip portion N to the lowest possible value (for example, zero). This structure reduces the degree of curve of the sheet P to zero in the nip portion and reduces curling and the transport path difference to the lowest possible value (for example, zero).

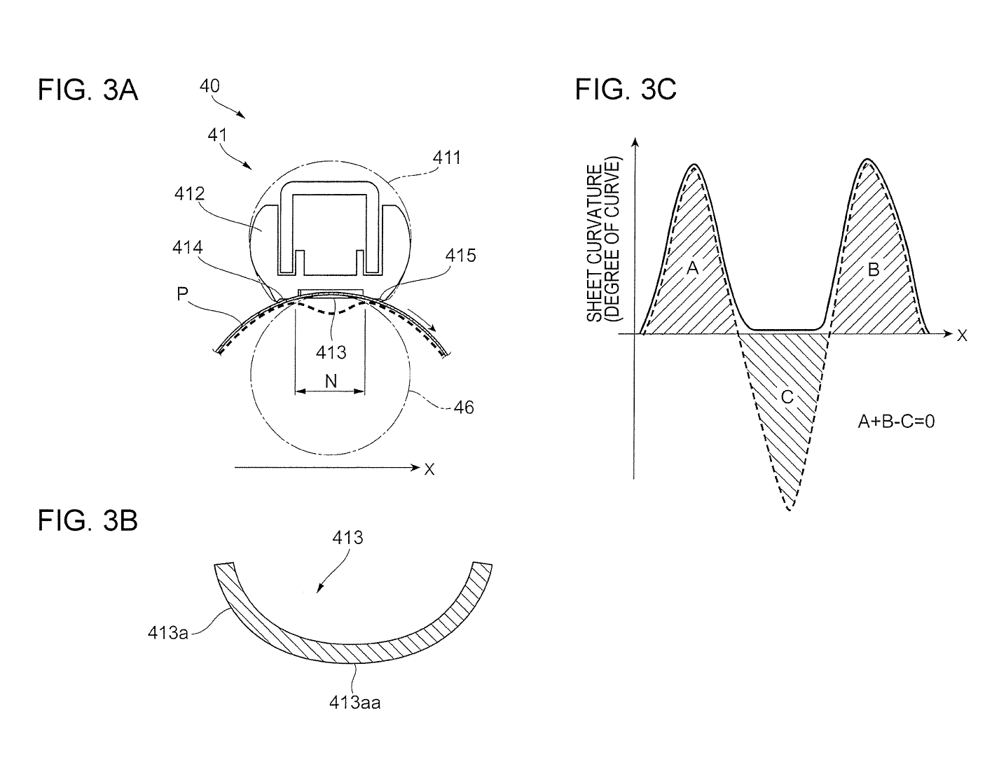

Here, a base member 413a of the flat heater of the heater 413 (see FIG. 3B) is conceivably made of ceramics or a stainless steel (SUS). In the present exemplary embodiment, the base member 413a is made of the latter material. Thus, the heater 413 having an intended projection shape is allowed to have reliable durability.

Exemplary embodiments including a first exemplary embodiment, a second exemplary embodiment, a third exemplary embodiment, and a fourth exemplary embodiment are specifically described below.

FIGS. 3A to 3C illustrate a fixing device 40 according to a first exemplary embodiment, where FIG. 3A is a schematic diagram of the fixing device 40, and FIG. 3B is a sectional view of the heater 413 having a projection shape. FIG. 3C is a graph showing the curvature of the sheet P, where the horizontal axis represents the position X in the sheet transport direction and the vertical axis represents the curvature (degree of curve) of the sheet P.

The broken lines illustrated in FIGS. 3A and 3C indicate the degree of curve of the sheet P in an exaggerated manner. In FIG. 3C, the curvature of the sheet P caused by the upstream protrusion 414 is denoted by a region A, and the curvature of the sheet P caused by the downstream protrusion 415 is denoted by a region B. The curvature of the sheet P caused by the heater 413 having the projection shape is denoted by a region C.

As illustrated in FIG. 3A, the support member 412 has the upstream protrusion 414 and the downstream protrusion 415 located off the nip portion N. As illustrated in FIG. 3C, the upstream protrusion 414 provides the curvature of the region A to the sheet P, and the downstream protrusion 415 provides the curvature of the region B, in the same direction of the region A, to the sheet P.

As illustrated in FIGS. 3A and 3B, the heater 413 of the fixing device 40 according to the first exemplary embodiment includes a base member 413a having a projection shape or an arc shape. More specifically, the arc-shaped base member 413a has an apex 413aa at substantially the center of the cross section. As illustrated in FIG. 3C, the apex 413aa of the base member 413a provides the curvature of a region C, in the direction opposite to the regions A and B, to the sheet P.

The heater 413 has a projection shape that provides the curvature of the region C corresponding to the sum of the curvatures of the regions A and B (A+B=C). This structure allows the sheet P to reduce the degree of curve caused by the upstream protrusion 414 and the downstream protrusion 415 to a minimum by passing through the nip portion N. This structure also allows the sheet P to reduce the curling and transport path difference to a minimum. Here, as long as the curvature of the region C is oriented in the direction opposite to the curvatures of the regions A and B, the curling is reduced.

As described above, the heater 413 having a projection shape (apex 413aa) in the nip portion N is capable of correcting the sheet P bent by the upstream protrusion 414 and the downstream protrusion 415, located off the nip portion N.

The amount of protrusion of the apex 413aa of the heater 413 is smaller than the amount of protrusion of the upstream protrusion 414 and smaller than the amount of protrusion of the downstream protrusion 415. Specifically, in the cross section including the pressing roller 46 and the fixing belt 411, the protruding ends of the upstream protrusion 414 and the downstream protrusion 415 and the protruding end of the apex 413aa are located at different positions. More specifically, the protruding ends of the upstream protrusion 414 and the downstream protrusion 415 are located closer to the pressing roller 46 than is the protruding end of the apex 413aa.

The reason for this positioning is described as follows. The apex 413aa is located within the nip portion N, whereas the upstream protrusion 414 and the downstream protrusion 415 are located off the nip portion N. Thus, the apex 413aa has a larger curling effect than the upstream protrusion 414 and the downstream protrusion 415.

In a structure that includes either one of the upstream protrusion 414 and the downstream protrusion 415, the curvature of the region C illustrated in FIG. 3C is determined to be equal to the curvature of the region A or the region B.

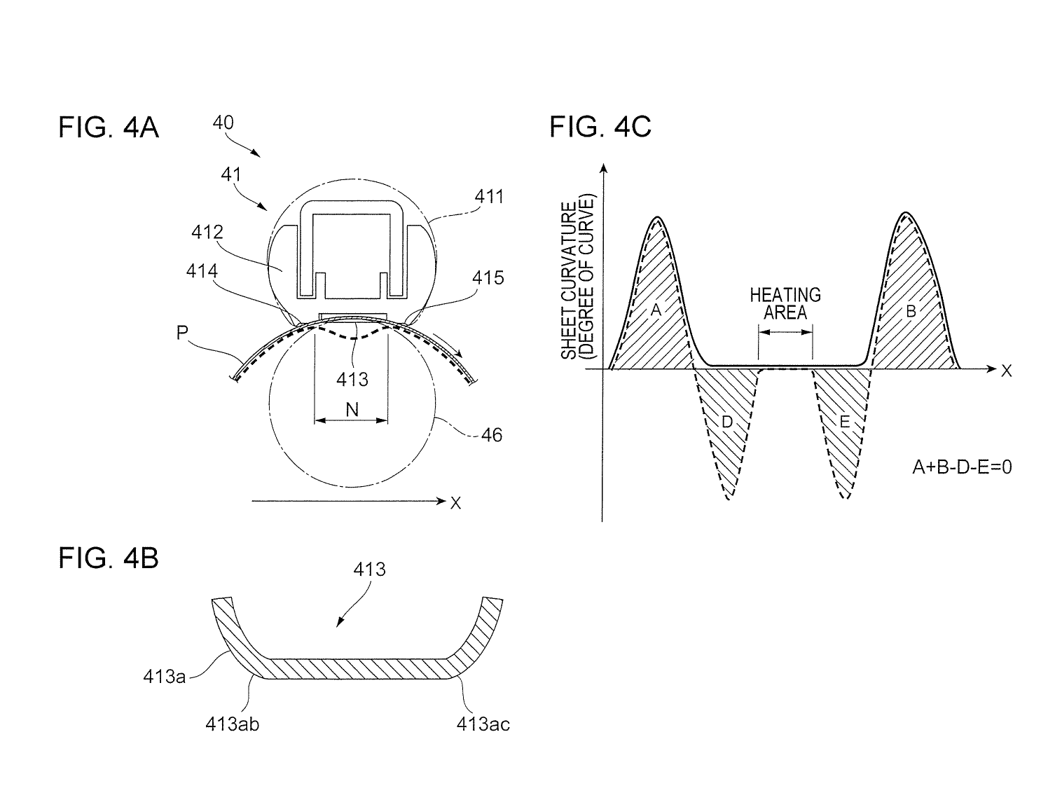

FIGS. 4A to 4C illustrate a fixing device 40 according to a second exemplary embodiment, where FIG. 4A is a schematic diagram of the fixing device 40, FIG. 4B is a sectional view of the heater 413 with a projection shape, and FIG. 4C is a graph showing the curvature of a sheet P. In the graph, the horizontal axis represents the position X in the sheet transport direction and the vertical axis represents the curvature (degree of curve) of the sheet P. FIGS. 4A to 4C correspond to FIGS. 3A to 3C, respectively.

As illustrated in FIGS. 4A and 4B, the heater 413 of the fixing device 40 according to the second exemplary embodiment includes the base member 413a having a projection portion whose cross section has a substantially straight portion. More specifically, the base member 413a includes corners 413ab and 413ac, each at the boundary between the substantially straight portion and a rounded portion. The corners 413ab and 413ac are located at positions different from the substantially center position in the cross section.

To be more specific, the base member 413a according to the second exemplary embodiment is different from the arc-shaped base member according to the first exemplary embodiment in terms of the cross section. Specifically, in the second exemplary embodiment, the base member 413a has two protrusions (corners 413ab and 413ac) to provide reverse curling to the sheet P separately twice. In the second exemplary embodiment, the amount of protrusion of a projection portion is allowed to be reduced than in the case of the first exemplary embodiment including the base member 413a having a single projection portion (apex 413aa). In this structure, bending of the sheet P in the reverse direction provided by an additional component affects the sheet P to the lesser extent.

In the second exemplary embodiment, as illustrated in FIG. 4C, the corner 413ab of the base member 413a provides the curvature of a region D, oriented in the direction opposite to the curvatures of the regions A and B, to the sheet P. The corner 413ac of the base member 413a provides the curvature of a region E, in the same direction as the curvature of the region D, to the sheet P. The projection portions of the heater 413 are shaped so that the sum of the curvatures of the regions D and E corresponds to the sum of the curvatures of the regions A and B (A+B=D+E). The sheet P thus reduces the degree of curve caused by the upstream protrusion 414 and the downstream protrusion 415 to a minimum by passing through the nip portion N. The sheet P also reduces the curling and the transport path difference to a minimum. The fixed sheet P is thus allowed to reduce deformation.

As in the case of the first exemplary embodiment, in the second exemplary embodiment, the protruding ends of the upstream protrusion 414 and the downstream protrusion 415 are closer to the pressing roller 46 than are the protruding ends of the corners 413ab and 413ac in the cross section including the pressing roller 46 and the fixing belt 411.

Here, as illustrated in FIG. 4C, the heating area (area including a heating layer) of the heater 413 is located between the regions D and E. Specifically, the heating area is located in the area different from the bent area. Alternatively, an example where the bent area and the heating area partially overlap each other is also conceivable.

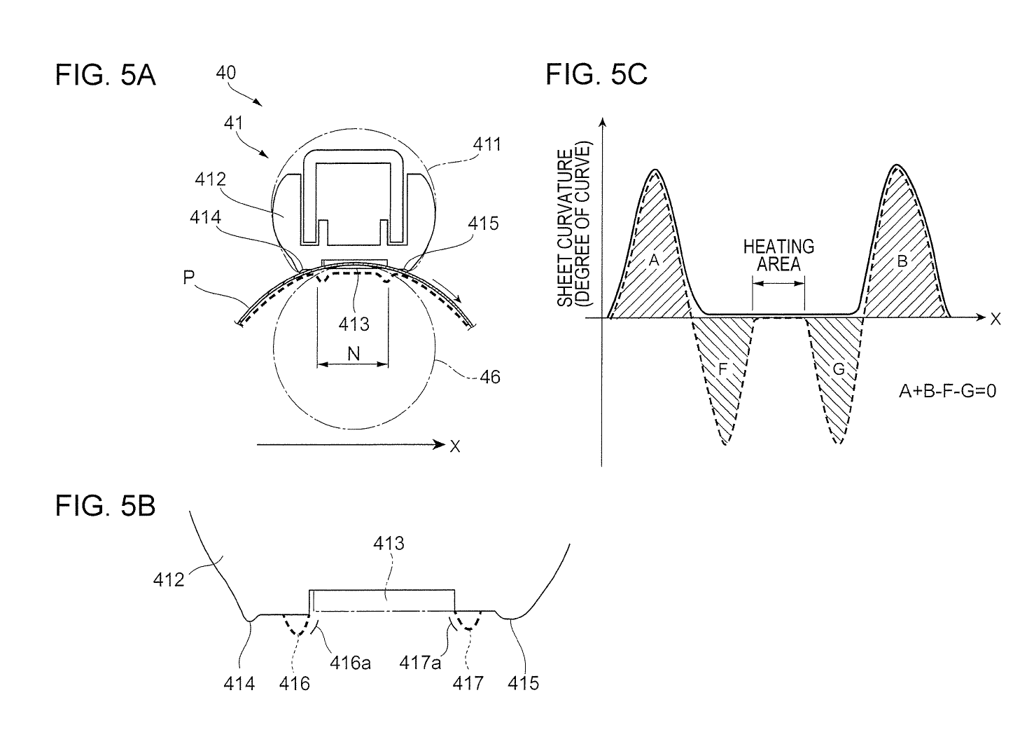

FIGS. 5A to 5C illustrate a fixing device 40 according to a third exemplary embodiment, where FIG. 5A is a schematic diagram of the fixing device 40, FIG. 5B is a sectional view of a support member 412 with a projection shape, and FIG. 5C is a graph showing the curvature of a sheet P. In the graph, the horizontal axis represents the position X in the sheet transport direction, and the vertical axis represents the curvature (degree of curve) of the sheet P. FIGS. 5A to 5C respectively correspond to FIGS. 3A to 3C or FIGS. 4A to 4C.

As illustrated in FIGS. 5A and 5B, in the fixing device 40 according to the third exemplary embodiment, portions of the support member 412 protrude toward the pressing roller 46. Specifically, as illustrated in FIG. 5B, the support member 412 includes protruding portions 416 and 417, which protrude toward the pressing roller 46. The protruding portions 416 and 417 are located in the nip portion N.

In FIG. 5B, in the cross section including the pressing roller 46 and the fixing belt 411, the protruding portions 416 and 417 protrude to a larger extent than the upstream protrusions 414 and the downstream protrusion 415. The fact is opposite: in the third exemplary embodiment, the protruding ends of the upstream protrusion 414 and the downstream protrusion 415 are closer to the pressing roller 46 than the protruding ends of the protruding portions 416 and 417, as in the cases of the first and second exemplary embodiments.

To be more specific, the protruding portions 416 and 417 of the support member 412 are located near the heater 413. Specifically, the protruding portion 416 is located upstream of the heater 413 in the sheet transport direction, and the protruding portion 417 is located downstream of the heater 413 in the sheet transport direction.

To be more specific, the third exemplary embodiment is different, in terms of the support member 412 includes the protruding portions 416 and 417, from the first exemplary embodiment, in which the base member 413a of the heater 413 has the apex 413aa, or the second exemplary embodiment, which includes the corners 413ab and 413ac.

More specifically, the third exemplary embodiment is the same, in terms of including two protruding portions, as the second exemplary embodiment, which includes the two corners 413ab and 413ac. However, the shapes of the protruding portions 416 and 417 are different from the shapes of the corners 413ab and 413ac. Specifically, as illustrated in FIG. 5B, the protruding portions 416 and 417 according to the third exemplary embodiment, which include opposing surfaces 416a and 417a facing each other, are different from the corners 413ab and 413ac (see FIG. 4B), which do not include such opposing surfaces. Thus, the opposing surfaces 416a and 417a are capable of more reliably bending the sheet P.

The third exemplary embodiment is capable of employing an existing heater as the heater 413, and only involves a change of the structure of the resin-made support member 412, which is capable of reducing a cost increase.

In the third exemplary embodiment, as illustrated in FIG. 5C, the protruding portion 416 of the support member 412 provides the curvature of the region F, oriented in the direction opposite to the curvatures of the regions A and B, to the sheet P, and the protruding portion 417 provides the curvature of the region G, in the same direction as the curvature of the region F, to the sheet P. The projection portions of the support member 412 have such shapes that the sum of the curvatures of the regions F and G is equal to the sum of the curvatures of the regions A and B (A+B=F+G).

Thus, the sheet P reduces the degree of curve caused by the upstream protrusion 414 and the downstream protrusion 415 to a minimum by passing through the nip portion N. The sheet P also reduces the curling and the transport path difference to a minimum. Thus, the fixed sheet P is allowed to reduce deformation. Here, as long as the curvatures of the regions F and G are oriented in the direction opposite to the curvatures of the regions A and B, the curling is reduced.

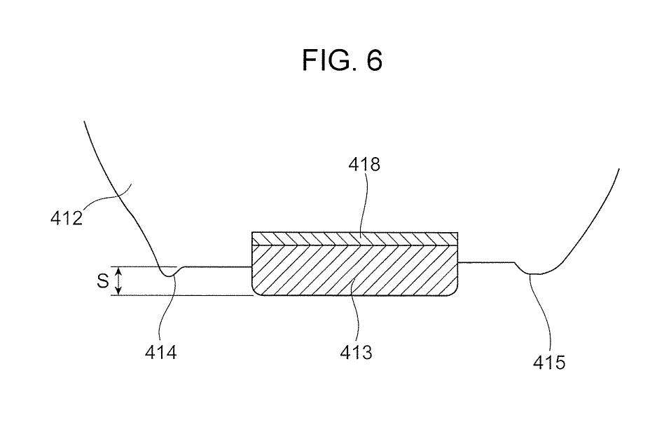

FIG. 6 illustrates a related portion of a fixing device 40 according to a fourth exemplary embodiment, and corresponds to, for example, FIG. 5B.

As illustrated in FIG. 6, the fixing device 40 according to the fourth exemplary embodiment includes a spacer 418, interposed between the support member 412 and the heater 413. The spacer 418 causes the heater 413 to protrude toward the pressing roller 46 beyond the surface of the support member 412. The amount of protrusion here is S. The heater 413 protrudes to a larger extent than the upstream protrusion 414 and the downstream protrusion 415.

Corners of the heater 413 upstream and downstream in the sheet transport direction, which are caused by the spacer 418 to protrude toward the pressing roller 46, provide the curvatures oriented in the direction opposite to the curvatures of the regions A and B, to the sheet P. The fixed sheet P is thus allowed to reduce deformation.

Here, in the fourth exemplary embodiment, unless the spacer 418 is included, the heater 413 does not exert an effect of reversely bending the sheet P. In other words, an existing heater is usable as the heater 413 according to the fourth exemplary embodiment. Compared to other exemplary embodiments, the heater 413 according to the fourth exemplary embodiment more easily allows a change of a structure for preventing deformation of the fixed sheet P. The spacer 418 does not have to be disposed over the entire surface of the heater 413 that comes into contact with the support member 412. The spacer 418 only has to be disposed on part of the surface of the heater 413 that comes into contact with the support member 412, for example, may be disposed on a center portion of the surface in the sheet transport direction. Such a structure forms an air layer between the heater 413 and the support member 412, which prevents the heat of the heater 413 from diffusing to the support member 412.

As in the case of the first to third exemplary embodiments, also in the fourth exemplary embodiment, in the cross section including the pressing roller 46 and the fixing belt 411, the protruding ends of the upstream protrusion 414 and the downstream protrusion 415 and the surface of the heater 413 are located at different positions. More specifically, as illustrated in FIG. 6, the surface of the heater 413 is located closer to the pressing roller 46 than the protruding ends of the upstream protrusion 414 and the downstream protrusion 415. Alternatively, the opposite case is also conceivable: that is, the protruding ends of the upstream protrusion 414 and the downstream protrusion 415 are located closer to the pressing roller 46 than the surface of the heater 413.

To be more specific, a modification example of the fourth exemplary embodiment, which includes the spacer 418, may exclude the spacer 418 by including another heater thicker than the heater 413 according to the fourth exemplary embodiment. More specifically, the thicker heater protrudes toward the pressing roller 46 further than do the upstream protrusion 414 and the downstream protrusion 415 without the spacer 418 interposed between itself and the support member 412. The structure including an existing heater thicker by the thickness of the spacer 418 (other than the heater 413 according to any of the first to third exemplary embodiments) is capable of preventing deformation of the fixed sheet P.

Thus, the apex 413aa of the base member 413a according to the first exemplary embodiment, the corners 413ab and 413ac of the base member 413a according to the second exemplary embodiment, the protruding portions 416 and 417 of the support member 412 according to the third exemplary embodiment, and the heater 413 according to the fourth exemplary embodiment regulate the shape of the fixing belt 411 at the nip portion N formed by pressing of the pressing roller 46 and the fixing belt 411 each other, and are examples of a second regulating portion. The heater 413 according to the fourth exemplary embodiment is also an example of a heat supply portion.

The present invention has been described using some exemplary embodiments. However, the technical scope of the present invention is not limited to the above-described exemplary embodiments. It is clear to persons having ordinary skill in the art that the present invention is allowed to be changed in various manners or modified into alternative forms without departing from the spirit or scope of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device, comprising:
a pressing member that is rotatably held and performs pressing in one direction;
a contact member that is rotatably held facing the pressing member, the contact member forming a nip portion through which a recording medium passes between the contact member and the pressing member, the contact member coming into contact with the recording medium;
first regulating portions that protrude from portions adjacent to the contact member toward the pressing member at positions upstream and downstream of the nip portion in a rotation direction of the contact member to regulate a shape of the contact member; and
a second regulating portion that is located in the nip portion and protrudes from a portion adjacent to the contact member toward the pressing member to regulate the shape of the contact member.

2. The fixing device according to claim 1, wherein the second regulating portion is disposed on a heating member having a heating area.

3. The fixing device according to claim 2, wherein the heating area of the heating member is flat.

4. The fixing device according to claim 1, wherein, in a cross section including the pressing member and the contact member, protruding ends of the first regulating portions and a protruding end of the second regulating portion are located at different positions.

5. The fixing device according to claim 4, wherein the protruding ends of the first regulating portions are located closer to the pressing member than is the protruding end of the second regulating portion.

6. A fixing device, comprising:
a pressing member that is rotatably held and performs pressing in one direction;
a contact member that is rotatably held facing the pressing member, the contact member forming a nip portion through which a recording medium passes between the contact member and the pressing member, the contact member coming into contact with the recording medium;
a support member that supports the contact member;
a regulating portion that is supported by the support member, the regulating portion protruding from a portion adjacent to the contact member toward the pressing member at at least one of positions upstream and downstream of the nip portion in a rotation direction of the contact member to regulate a shape of the contact member; and
a heat supply portion that protrudes toward the pressing member beyond a surface of the support member excluding the regulating portion to supply heat to the nip portion.

7. The fixing device according to claim 6, further comprising a member interposed between the support member and the heat supply portion, the member causing the heat supply portion to protrude toward the pressing member further than does the support member.

8. An image forming apparatus, comprising:
an image forming device that forms an image on a recording medium; and
a fixing device that fixes the image formed on the recording medium by the image forming device onto the recording medium,
wherein the fixing device is the device according to claim 1.
